(19) United States
(12) Patent Application Publication
(10) Pub. No.: US 2022/0414701 A1
(43) Pub. Date: Dec. 29, 2022

(54) SYSTEMS AND METHODS TO PAY WITH POINTS TO DIGITAL MERCHANTS

(71) Applicant: IGUAMA, INC., Miami, FL (US)

(72) Inventor: Diego Fernandez, Guatemala (GT)

(73) Assignee: Rewardsweb, Inc., Miami, FL (US)

(21) Appl. No.: 17/766,510

(22) PCT Filed: Oct. 5, 2020
(86) PCT No.: PCT/US2020/054287

§ 371 Date: Apr. 4, 2022

Related U.S. Application Data
(60) Provisional application No. 62/910,808, filed on Oct. 4, 2019.

(51) Int. Cl. G06Q 30/02; G06Q 20/38

(52) U.S. Cl. CPC G06Q 30/0227; G06Q 20/381

(57) ABSTRACT

An intermediary application enables loyalty program members to redeem their loyalty points or miles through purchases with a merchant different from the business entity associated with the member's loyalty program. Members of a loyalty program pay merchants using loyalty points in exchange for goods and services. A virtual credit card is created to complete the purchase from the online merchant. Customer behavior is collected at the SKU level to help a loyalty program get to know their members better and further enhance the customer experience overall.

### PRIORITY

This application claims the benefit of U.S. Provisional 62/910,808 filed Oct. 4, 2019, which is hereby incorporated by reference as submitted in its entirety.

### FIELD OF THE INVENTION

The present disclosure relates to systems and methods to pay with loyalty points, miles or similar in exchange for goods and/or services from digital merchants while collecting user behavior at SKU-or specific service level to help the loyalty programs get to know their members better.

### BACKGROUND

Different marketing strategies, such as company loyalty programs, sometimes referred to as rewards programs, encourage customers to stay loyal to a certain business. Based on purchases and other interactions a customer has with a certain business and its partners, the business or its partners may award the customer, such as with points, miles, or by other means in order to help the business get loyal customers. All these different interactions and the information collected from such interactions help the business get to know their members better in order to continue developing products and services tailored to their constant evolving needs.

In some cases, these points or reward redemptions may be saved over time and exchanged for goods and services with that same business. For example, hotel chains like Hilton® or Marriott® award points to members that may be used at a later date for hotel redemptions, such as free nights.

Limitations of loyalty programs arise when a customer accumulates many points with a certain vendor but desires to make a purchase elsewhere, such as with another business entity entirely. For example, a consumer may accumulate many points with a hotel chain but may feel frustrated when they desire goods or services offered by another business entity but lack the funds or the ability to purchase the desired goods or services of the other business entity.

About 100 billion dollars' worth of loyalty points go unclaimed by consumers participating in brand loyalty programs. Many different reasons factor in as to why consumers fail to claim accumulated loyalty points. In some instances, businesses entities fail to communicate to consumers their loyalty point balances and how to actually redeem accumulated loyalty points. In other instances, consumers hoard their accumulated points and maintain a minimum balance for emergency situations. In another instance, consumers build up point balances over a long period of time and use them to take a once-in-a-lifetime vacation. What is needed is a method to drive consumer engagement with business loyalty programs and provide technological advances to business loyalty program awareness and engagement.

### BRIEF SUMMARY

The present embodiments may relate to systems and methods including an environment, via a desktop application or a mobile application, for example, whereby an intermediary application enables loyalty program members to redeem their loyalty points or miles through purchases with a merchant different from the business entity associated with the member's loyalty program. The disclosed embodiments enable members of certain loyalty programs to redeem their loyalty points with their favorite online stores. In some embodiments, a virtual credit card may be created to complete the purchase from the merchant.

In one embodiment, an intermediary computing device comprising at least one processor in communication with a memory device may be provided. The at least one processor may be configured to receive, from a loyalty program server, user data pertaining to at least one user, receive, from at least one merchant, data identifying one or more goods or services, receive, from at least one user device associated with the at least one user, a request to purchase at least one of the one or more goods or services, and receive, from at least one payment server, payment information to complete the at least one requested purchase. The processor may further be configured to collect and subsequently provide SKU-level data pertaining to one or more users to the loyalty program server.

The intermediary computing device may be further configured to: assign a point value to the identified one or more goods or services, display an exchange ratio of the assigned point value to a currency of the user, notify the loyalty program server of the completed purchase, wherein the notification includes a point value of the purchased good or service and receive a bill in an amount equal the cost of the purchased good or service, and send a bill for the amount to the loyalty program server.

In some embodiments, the loyalty server may link an account of the user with the intermediary computing device with an account of the user with the loyalty program server. The intermediary computing device may include additional, less, or alternate actions, including those discussed elsewhere herein.

In another embodiment of the disclosed invention, a computer-based method for creating a virtual payment may be provided. The method may include receiving a request, from a computing device, for a virtual payment instrument, creating the virtual payment instrument, setting a value of the virtual payment instrument, and providing the virtual payment instrument. The request may include a name of a user, a merchant code, and an amount, wherein the set value is based on the amount, a credit limit of the virtual payment instrument is equal to the amount, and virtual payment instrument is a credit card, a debit card, a cash card, or a gift card. The embodiment may further include associating the virtual payment card with the user, reusing the virtual payment card for the user in a subsequent transaction, or canceling the virtual payment card after a single use. The computer-based method may include additional, less, or alternate actions, including those discussed elsewhere herein.

In yet another embodiment of the disclosed invention, the disclosed may include steps to create, for a consumer, a loyalty rewards account with at least one of a plurality of loyalty rewards programs, create, for the consumer, a loyalty redemption account with at least one loyalty redemption server, provide an interface between the loyalty rewards account and the loyalty redemption account, display, to the consumer, one or more of a plurality of goods or services provided by one or more of a plurality of online merchants, receive, from the consumer, a selection of at least one of the one or more of the plurality of goods or services, and provide, to the consumer, a secure method of payment to purchase the selected good or service. The disclosed may further include the steps to provide an overlay graphic indicating an exchange rate of the one or more of goods and services between loyalty points and a currency native to the consumer. In some embodiments, the exchange rate is contracted between the at least one of the plurality of loyalty rewards programs and the loyalty redemption server.

In some embodiments of the disclosed, the at least one of the plurality of loyalty rewards programs and the loyalty redemption server interface via an application programming interface. Further, the overlay graphic may be provided via a browser extension for display to the consumer. In some embodiments, the one or more of the plurality of goods or services of the plurality of online merchants may be displayed on a screen of a mobile application associated with the loyalty redemption server.

Advantages will become more apparent to those skilled in the art from the following description of the preferred embodiments which have been shown and described by way of illustration. As will be realized, the present embodiments may be capable of other and different embodiments, and their details are capable of modification in various respects. Accordingly, the drawings and description are to be regarded as illustrative in nature and not as restrictive.

### BRIEF DESCRIPTION OF THE DRAWINGS

The Figures described below depict various aspects of the systems and methods disclosed therein. It should be understood that each Figure depicts an embodiment of a particular aspect of the disclosed systems and methods, and that each of the Figures is intended to accord with a possible embodiment thereof. Further, wherever possible, the following description refers to the reference numerals included in the following Figures, in which features depicted in multiple Figures are designated with consistent reference numerals.

There are shown in the drawings arrangements which are presently discussed, it being understood, however, that the present embodiments are not limited to the precise arrangements and are instrumentalities shown, wherein:

FIG. 1 is a simplified functional block diagram of a computer system in accordance with the embodiments of the disclosed invention;

FIG. 2 illustrates an exemplary computing device in accordance with at least one embodiment of the disclosed invention;

FIGS. 3A-31 illustrate a series of exemplary screenshots in accordance with one or more embodiments of the disclosed invention;

FIG. 4 illustrates a simplified functional block diagram of a computer network in accordance with at least one embodiment of the disclosed invention;

FIGS. 5A and 5B illustrate an exemplary process in accordance with one or more embodiments of the disclosed invention; and

FIG. 6 illustrates an exemplary process in accordance with one or more embodiments of the disclosed invention.

The Figures depict preferred embodiments for purposes of illustration only. One skilled in the art will readily recognize from the following discussion that alternative embodiments of the systems and methods illustrated herein may be employed without departing from the principles of the invention described herein.

### DETAILED DESCRIPTION OF THE INVENTION

The present embodiments may relate to, inter alia, systems and methods for a redemption process of loyalty program points through purchases with an online merchant unaffiliated with the loyalty program.

In some embodiments, the systems and methods described herein may include a desktop environment whereby an intermediary application enables loyalty program members to redeem their loyalty points or miles through purchases with a merchant different from the business entity associated with the member's loyalty program. In some embodiments, the merchant may be located in another country. In some embodiments, a virtual credit card may be created to complete the purchase from the online merchant.

In some embodiments, the systems and methods described herein may include a mobile application whereby an intermediary application enables loyalty program members to redeem their loyalty points or miles through purchases with a merchant different from the business entity associated with the member's loyalty program. In some embodiments, the merchant may be located in another country. In some embodiments, a virtual credit card may be created to complete the purchase from the online merchant.

In some embodiments, the systems and methods described herein may include tracking customer shopping behavior. Shopping behavior may include, but is not limited to, stores visited, products viewed, products purchased, price ranges of products viewed/purchased, as well as products returned, for example. In one example, a product returned may signal a customer's dissatisfaction with a product. Customer behavior data may then be collected and provided to loyalty program to enhance user experience. For example, shopping behavior data may be leveraged to personalize a user experience and provide a customer with product suggestions. Typical product suggestions may relate to items previously viewed by a user, for example. In another example, product suggestions may be of the same genre or category of items previously viewed by a user. In some embodiments, an intermediary application may track customers and collect SKU-level data. SKU-level data may include what purchases have been made by a customer as well as method of payment (e.g., debit card, credit card, etc.). SKU-level data may also influence how loyalty programs interact with customers, such as via advertising of certain products or providing featured items at a discount when purchased using loyalty points.

In some embodiments, the systems and methods described herein may include a virtual card program whereby an intermediary application enables loyalty program members to redeem their loyalty points or miles through purchases with a merchant unaffiliated with the business entity associated with the member's loyalty program. In some embodiments, the merchant may be located in another country.

In some embodiments, the systems and methods described herein may include a combination of the aforementioned desktop environment, web extension, mobile application, or virtual card program whereby an intermediary application enables loyalty program members to redeem their loyalty points or miles through purchases with a merchant different from the business entity associated with the member's loyalty program. In some embodiments, the merchant may be located in another country.

As described below, systems and methods described drive member engagement with loyalty programs by enabling the expenditure of earned loyalty points/miles with another merchant. As used herein, a “loyalty program” refers to a program designed by a business entity intended to provide consumers with reward points/miles/cashback in exchange for interacting or conducting transactions with the business entity, and “member” refers to any person or consumer that earns points/miles/cashback with a loyalty program for interacting or conducting transactions with the business entity. As used herein, loyalty “points” or “miles” refers to reward amounts accumulated by consumers for making purchases with a business having a loyalty program. As used herein, “merchant” refers to any type of storefront selling goods or services, online or offline.

At least one of the technical problems addressed by this system may include: (i) handling of big data processing with respect to user records, user loyalty program membership data; (ii) systems integrations between loyalty programs in a certain geographical location and merchants in a different geographical location unaffiliated with loyalty programs; and (iii) enable consumers to make purchases using loyalty program redemption methods in non-native currency.

A technical effect of the systems and processes described herein may be achieved by performing at least one of the following steps: (a) providing at least one web browser extension for consumers to fully realize the capabilities of the described embodiments; and (b) providing a gateway for consumers to access goods and services not normally made available to them because of geographical and technological restrictions.

Another technical problem addressed by the systems and processes described herein may include: (i) redemption of accumulated reward points or miles for goods or services not available for purchase using the reward points or miles; (ii) enabling the redemption of accumulated reward points or miles for goods or services by an intermediary server, whereby the intermediary server generates a virtual cash card in an amount equal to the value of the reward points or miles; and (iii) enabling the purchase of the goods or services utilizing the virtual cash card for payment to a merchant providing the goods or services sought out by the consumer.

In some embodiments of the disclosed invention, virtual cash cards (e.g. credit, debit, gift) may be created for members that may leverage several types of card controls. The first time a card is created, a spending limit may be applied to ensure the card can only be charged for the exact amount of an intended purchase. Once charged, the card balance will fall to $0 but the card will not expire. In an exemplary embodiment, the card may be configured as a multi-use product. In another embodiment, the card may be configured as a single-use product. A multi-use card may allow a member to re-use a card whereby the next time the member wishes to make a payment with accumulated membership points, the multi-use card may be reloaded with the exact amount of funds needed to cover the intended purchase. Additionally, a merchant category code control may be used to limit the cards to use with the intended merchant type.

In some embodiments of the disclosed invention, transaction data may be collected to improve system operation and optimize a customer's online experience. For example, customer buying patterns may be detected based on historical transaction data collected with respect to a customer. Additionally, or alternatively, elements of each transaction, such as item purchased, shipping address, price paid, or the like, may be used to allow rewards programs, as well as merchants, dynamically learn about customers and, more specifically, customer behaviors.

In some embodiments of the disclosed invention, implementations of methods set forth herein may be deployed via mobile device application integration with existing applications, or apps. Additionally, or alternatively, implementations may be provided as an enhancement to a web browser, as a browser extension, or integrated with an existing browser extension, such as a Google® Chrome browser extension. In some embodiments, payment functionality using points may be implemented on different merchants. Further, payment implementation methods described herein may be integrated with existing browser extensions or apps via an SDK.

Exemplary Computer System

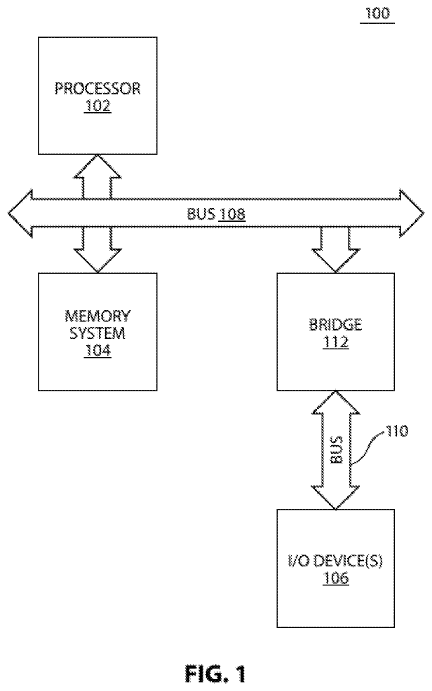

FIG. 1 is an example of a simplified functional block diagram of a computer system 100. The functional descriptions of the present invention can be implemented in hardware, software or some combination thereof.

As shown in FIG. 1, the computer system 100 includes a processor 102, a memory system 104 and one or more input/output (I/O) devices 106 in communication by a communication ‘fabric’. The communication fabric can be implemented in a variety of ways and may include one or more computer buses 108, 110 and/or bridge and/or router devices 112 as shown in FIG. 1. The I/O devices 106 can include network adapters and/or mass storage devices from which the computer system 100 can send and receive data for generating and transmitting advertisements with endorsements and associated news. The computer system 100 may be in communication with the Internet via the I/O devices 108.

Those of ordinary skill in the art will recognize that many modifications and variations of the present invention may be implemented without departing from the spirit or scope of the invention. Thus, it is intended that the present invention cover the modification and variations of this invention provided they come within the scope of the appended claims and their equivalents.

The various illustrative logics, logical blocks, modules, and engines, described in connection with the embodiments disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but, in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

Further, the steps and/or actions of a method or algorithm described in connection with the aspects disclosed herein may be embodied directly in hardware, in a software module executed by a processor, or in a combination of the two. A software module may reside in RAM memory, flash memory, ROM memory, EPROM memory, EEPROM memory, registers, a hard disk, a removable disk, a CD-ROM, or any other form of storage medium known in the art. An exemplary storage medium may be coupled to the processor, such that the processor can read information from, and write information to, the storage medium. In the alternative, the storage medium may be integral to the processor. Further, in some aspects, the processor and the storage medium may reside in an ASIC. Additionally, the ASIC may reside in a user terminal. In the alternative, the processor and the storage medium may reside as discrete components in a user terminal. Additionally, in some aspects, the steps and/or actions of a method or algorithm may reside as one or any combination or set of instructions on a machine readable medium and/or computer readable medium.

Exemplary Client Computing Device

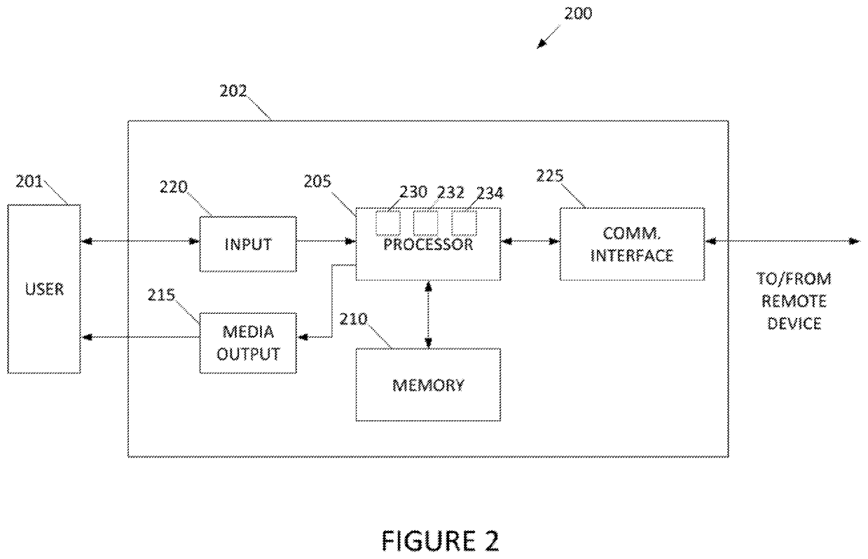

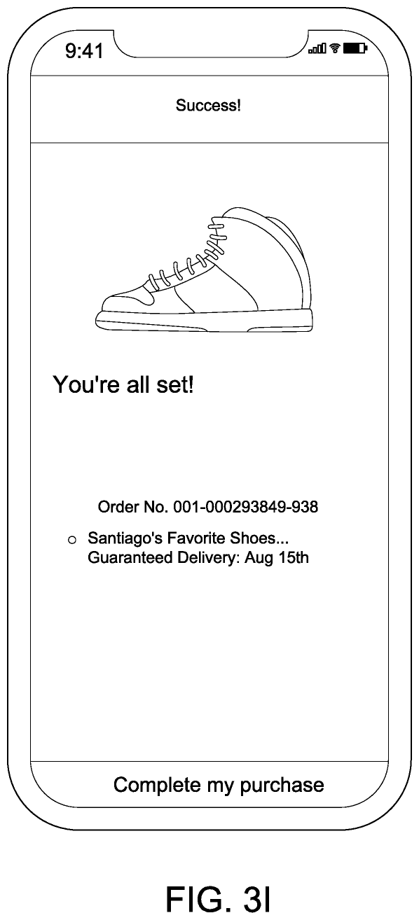

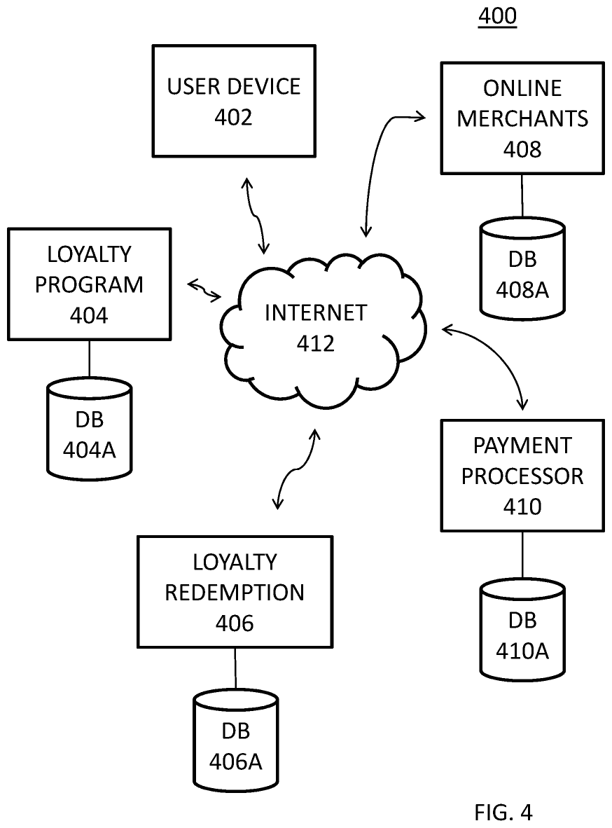

FIG. 2 depicts an exemplary client computing device 202 that may be used with the disclosed system described. Client computing device 202 may be, for example, at least one of the computing devices described in conjunction with FIG. 4.

Client computing device 202 may include a processor 205 for executing instructions. In some embodiments, executable instructions may be stored in a memory area 210. Processor 205 may include one or more processing units (e.g., in a multi-core configuration). Memory area 210 may be any device allowing information such as executable instructions and/or other data to be stored and retrieved. Memory area 210 may include one or more computer readable media.

In the exemplary embodiments, processor 205 may include and/or be communicatively coupled to one or more modules for implementing the systems and methods described herein.

In exemplary embodiments, client computing device 202 may also include at least one media output component 215 for presenting information to a user 201. Media output component 215 may be any component capable of conveying information to user 201. In some embodiments, media output component 215 may include an output adapter such as a video adapter and/or an audio adapter. An output adapter may be operatively coupled to processor 205 and operatively couplable to an output device such as a display device (e.g., a liquid crystal display (LCD), light emitting diode (LED) display, organic light emitting diode (OLED) display, cathode ray tube (CRT) display, “electronic ink” display, or a projected display) or an audio output device (e.g., a speaker or headphones). Media output component 215 may be configured to, for example, display an alert message.

Client computing device 202 may also include an input device 220 for receiving input from user 201. Input device 220 may include, for example, a keyboard, a pointing device, a mouse, a stylus, a touch sensitive panel (e.g., a touch pad or a touch screen), a gyroscope, an accelerometer, a position detector, or an audio input device. A single component such as a touch screen may function as both an output device of media output component 215 and input device 220.

Client computing device 202 may also include a communication interface 225, which can be communicatively coupled to a remote device such as DI computing device 102 (shown in FIG. 1). Communication interface 225 may include, for example, a wired or wireless network adapter or a wireless data transceiver for use with a mobile phone network (e.g., Global System for Mobile communications (GSM), 3G, 4G or Bluetooth) or other mobile data network (e.g., Worldwide Interoperability for Microwave Access (WIMAX)).

Stored in memory area 210 may be, for example, computer-readable instructions for providing a user interface to user 201 via media output component 215 and, optionally, receiving and processing input from input device 220. A user interface may include, among other possibilities, a web browser and client application. Web browsers may enable users, such as user 201, to display and interact with media and other information typically embedded on a web page or a website.

Memory area 210 may include, but is not limited to, random access memory (RAM) such as dynamic RAM (DRAM) or static RAM (SRAM), read-only memory (ROM), erasable programmable read-only memory (EPROM), electrically erasable programmable read-only memory (EEPROM), and non-volatile RAM (NVRAM). The above memory types are exemplary only, and are thus not limiting as to the types of memory usable for storage of a computer program.

Exemplary Graphical User Interfaces

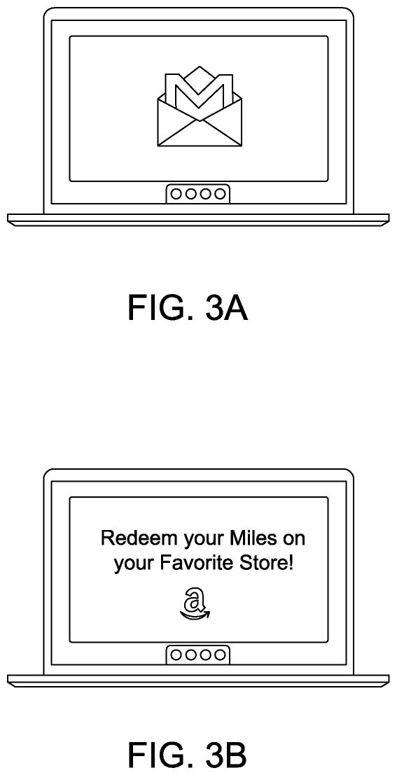

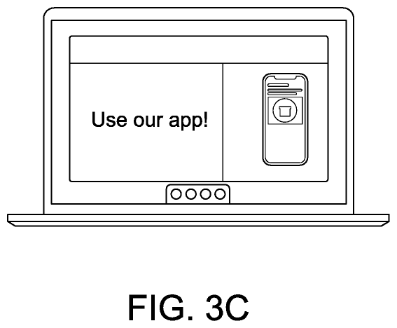

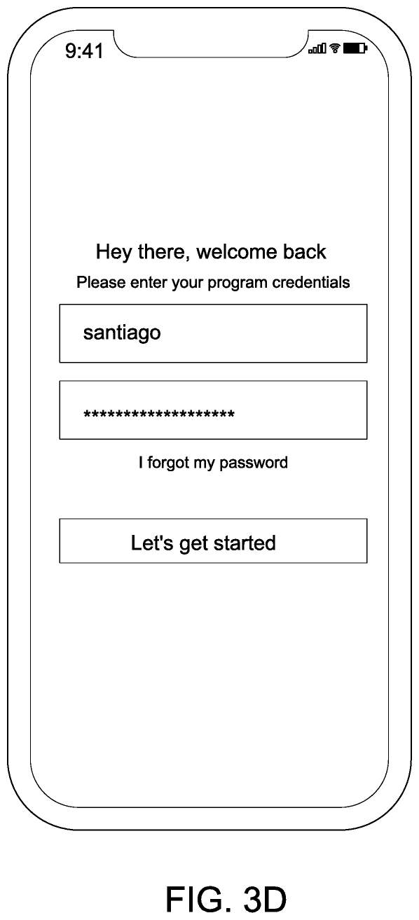

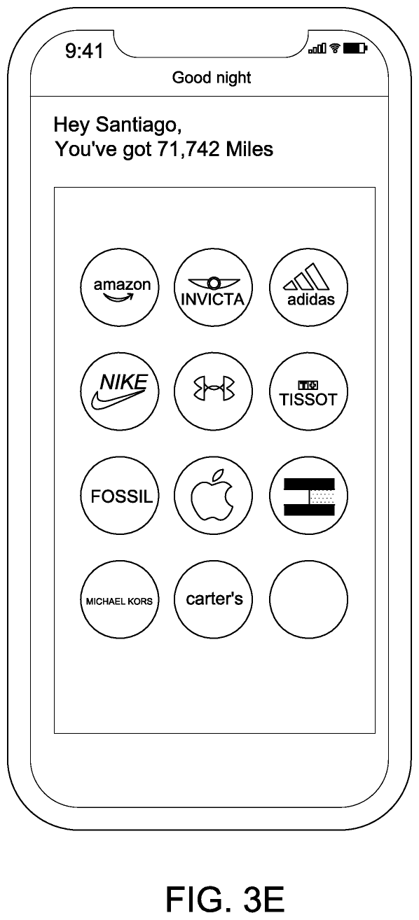

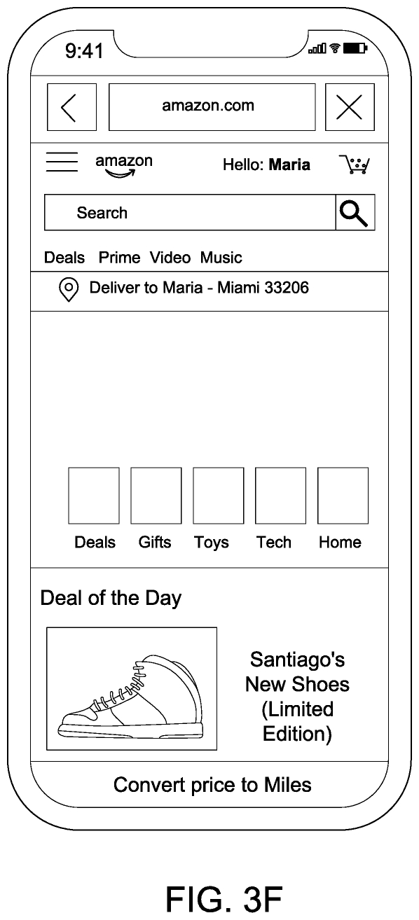

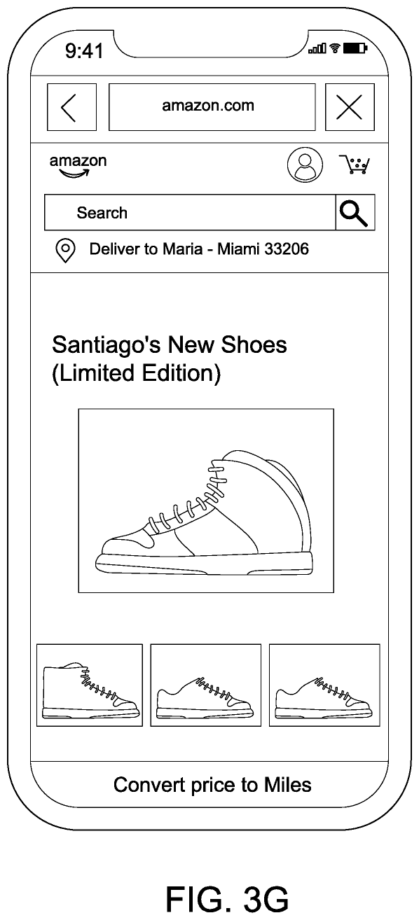

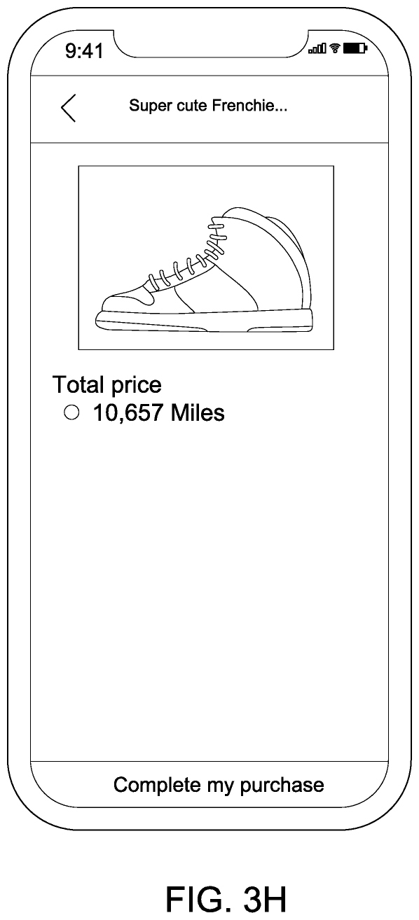

FIGS. 3A-31 depicts a series of exemplary device screenshots in accordance with one or more embodiments of the disclosed invention. It is understood that the screenshots included are exemplary and are not meant to be limiting in any way.

As shown in FIGS. 3A and 3B, a user may access messages transmitted from their loyalty program. In another embodiment, a user may receive one or more promotional emails from an intermediary server described further below with respect to FIG. 4. As shown in FIG. 3B, the user may be alerted to the ability to redeem accumulated miles to their favorite store, such as an online merchant. Links may be provided to access features of the disclosed invention, such as instruction page shown in FIG. 3C. As shown in FIG. 3C, a user may be directed to use a mobile application. A user would not be limited to using a mobile application. It is understood that the features of the disclosed invention may be provided and interacted with via a desktop platform, a tablet, a mobile device, or a combination thereof. In some embodiments, a user may initiate a transaction using a first type of device, such as a desktop, and complete the transaction at a later time on a second type of device, such as their mobile device.

As shown in FIG. 3D, a user may be provided access to the platform via a mobile application. A user may be shown a log-in screen and prompted to provide user credentials (e.g., username and password). Other types of authentication mechanisms may be used, such as biometrics scanning or multi-factor authentication mechanisms.

As shown in FIG. 3E, in response to a user providing valid credentials, the user may be shown a dashboard, for example. User information gleaned from the user's loyalty rewards' memberships may be shown. In another portion of the screen, the user may be shown a plurality of merchants available to make purchases from using the membership rewards points accumulated by the user. The displayed merchants are in no way meant to be limiting and merely shown for exemplary purposes.

A personalized shopping experience may be provided to the user once the user accesses at least one of the available merchants, as shown in FIG. 3F. As displayed, the user may be shown a typical online merchant screen overlaid with one or more features of the disclosed invention. The overlay may provide a user with special offers for different goods or services which may be of interest to the user based on market research, or other information, such as user preferences or past purchase history. As shown, a portion of the screen may provide a clickable tab to be shown price to rewards points/miles redemption cost. A user may select an item, such as a pair of shoes in FIG. 3G. As shown, the user may be provided with different views of the item along with similar items. Overlaid on at least a portion of the screen may be a clickable tab to be shown price to rewards points/miles redemption cost.

FIG. 3H illustrates an exemplary screen shown to a user in response to selection an option to be shown price to rewards points/miles redemption cost. If acceptable to the user, the user may be given the option to complete the purchase of the desired item. As shown in FIG. 3I, the user may be taken to a confirmation page that the purchase was a success. Purchase process may include a multi-process including, but not limited to, creation of a virtual payment, payment to the online merchant, deduction of the user's loyalty account, and billing of the loyalty program to cover the cost of the virtual payment. A commission may be included as a portion of the billing of the loyalty program.

Exemplary User Interfaces

FIG. 4 depicts an exemplary system of devices in accordance with at least one embodiment of the disclosed invention. FIG. 1 depicts an exemplary loyalty program redemption (LPR) system 400. LPR system 400 may include a Loyalty Redemption computing device 406. Loyalty Redemption computing device 406 may be communicatively coupled to a database 406A. For simplicity, a single database is shown for database 406A, however it is understood that database 406A may comprise a multitude of data storage solutions. Data storage solutions include, but certainly not limited to, an array of a series of databases, cloud storage options accessible via a network, such as Internet 412, local data storage options, or other data storage options as known in the art. Loyalty Redemption Server 406 may be communicatively coupled, via a network such as Internet 412, to one or more devices, including Loyalty Program Server 404, Online Merchants 408, and Payment Processor 410.

In some embodiments of the disclosed invention, a plurality of user devices may interact with one or more computing devices of the disclosed invention. For simplicity, a single user device is shown, User Device 402. User Device may be a mobile device. In another embodiment, the User Device may be a tablet PC. The user of a User Device 402 may a member of a loyalty program, which may be operated by Loyalty Program Server 404. Loyalty Program Server 404 may be communicatively-coupled to database 404A. Database 404A may represent a plurality of different data storage solutions described above. Database 404A may store user member information. For example, user member information may include a user's membership ID (e.g., membership number), member join date, member transaction history, points/miles earned, promotional data, and points/miles redeemed. For simplicity, a single Loyalty Program Server 404 is shown, however, it is understood that a plurality of different loyalty program servers may be supported by the disclosed. In some embodiments, a single user may be a member of more than one loyalty program.

FIG. 4 depicts one or more online merchants as Online Merchants 408. For simplicity, a single online merchant is shown, however a plurality of online merchants may be accessible via Internet 412. In some embodiments, an online merchant may have an agreement with one or more loyalty programs 404. In other embodiments, online merchants 408 may have their own loyalty programs which become accessible for loyalty redemption. As shown in FIG. 4, Loyalty Redemption Server 406 may be communicatively-coupled to Loyalty Program 404 and Online Merchants 408 via Internet 412. In one example, Loyalty Redemption Server 406 enables a shopper to browse items offered by Online Merchants 408 via User Device 402. Items may be purchased by redeeming points/miles of the shopper's loyalty program account, based on shopper data provided by Loyalty Program Server 404 and retrieved from Database 404A. Once a purchase is confirmed, Loyalty Redemption Server 406 may access Payment Processor 410 to enable the purchasing of the item. In one embodiment, Payment Processor 410 may provide a secure virtual cash card, similar to a credit card or gift card, loaded with funds to cover the cost of the purchased item. Payment Processor 410 may be communicatively-coupled to Database 410A. For simplicity, a single Payment Processor is shown in conjunction with a database, however it is understood that a plurality of different payment processors or clearinghouses may be utilized. Database 410A may be configured to store user identification, accounting records, purchase history, or the like.

Loyalty Redemption Server 406 may perform consumer loyalty redemption for goods and services not offered by a Loyalty Program 404 that a user of user device 402 is a member of. In some embodiments, a browser extension may be provided on a screen of User Device 402. During a web browsing session, a user may be alerted to the availability of points redemption in exchange for goods and services. For example, when a user browses a website of Online Merchant 408, an extension may provide an information box or bubble showing the price of certain goods or services offered by the Online Merchant. In some embodiments, along with the price, the amount of loyalty points/miles may be shown equal to the cost of the good or service. The browser extension may be provided with user data from Loyalty Program 404 and stored on database 404A, for example. In some embodiments, the user may link their Loyalty Program membership details, such as a membership number or the like, to a Loyalty Redemption Account. This information may be stored on Database 406A. Based on the data stored at database 406A, a user may purchase from Online Merchants 408 directly via the browser extension. The browser extension may be supported fully by the Loyalty Redemption server 406. Based on purchase confirmation, Loyalty Redemption Server may provide the necessary funds or currency needed to finalize the purchase from the Online Merchant 408. In one embodiment, purchase may be supported by a secure Payment Processor 410, such as a bank or credit card company. Once a purchase is finalized, a user's account with Loyalty Program 404 may be deducted for the converted price to miles/points and the Loyalty Redemption Server 406 may receive reimbursement from Loyalty Program 404. The reimbursement may be equal to the price of the goods or services purchased. In some embodiments, the reimbursement may include a commission to be paid to the Loyalty Redemption Server 406. In yet another embodiment, the added commission may be covered by a further points or miles deduction from the user's loyalty program account. Alternatively, the added commission may be paid by the Loyalty Program.

In some embodiments, a server, such as loyalty redemption server 406 may track customer shopping behavior and collect SKU-level data. Shopping behavior may include, but is not limited to, stores visited, products viewed, products purchased, price ranges of products viewed/purchased, as well as products returned, for example, by a customer of user device 402. Customer behavior data may then be collected and provided to loyalty program 404 and subsequently used to enhance a user's experience. Customer behavior data may be stored in database 404A, for example. In another embodiment, customer behavior data may be stored in database 406A. The collected user data may be provided to loyalty program 404 for a fee, for example. In another embodiment, the collected user data may be provided based on a contract between loyalty program 404 and loyalty redemption server 406.

Shopping behavior data may be leveraged by loyalty program 404 to personalize a user experience and provide a customer with product suggestions when provided with a portal to merchants, such as online merchants 408. In some embodiments product suggestions may relate to items previously viewed by a user, for example. In another example, product suggestions may be of the same genre or category of items previously viewed by a user. In some embodiments, an intermediary application, such as loyalty redemption 406, may track customers and collect SKU-level data. SKU-level data may include what purchases have been made by a customer as well as method of payment (e.g., debit card, credit card, etc.). SKU-level data may also influence how loyalty programs interact with customers, such as via advertising of certain products or providing featured items at a discount when purchased using loyalty points.

Exemplary Computer-Implemented Method for the Redemption of Loyalty Points in Exchange for Goods

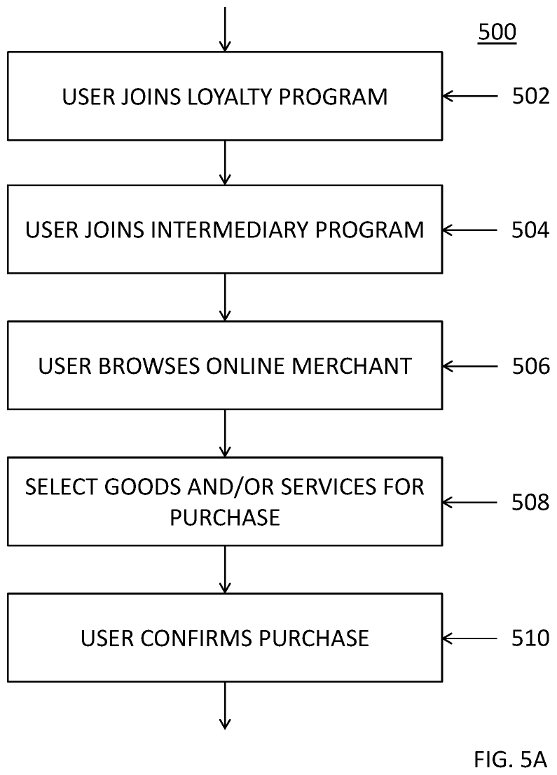

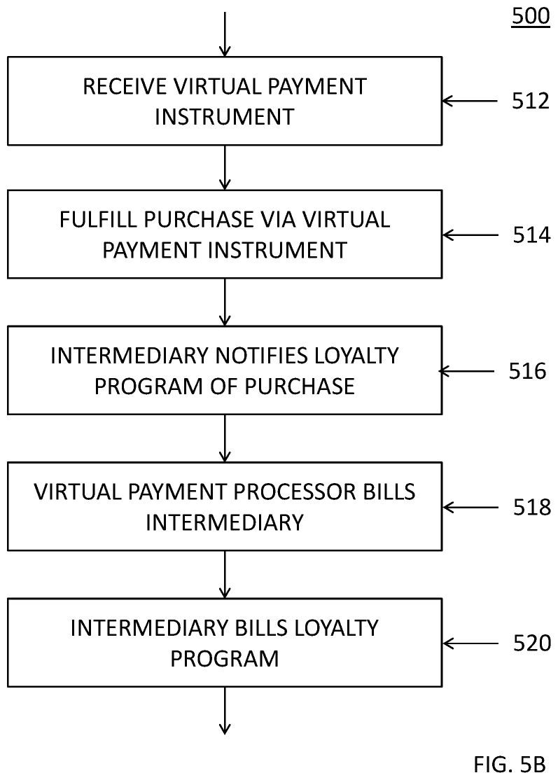

FIGS. 5A and 5B illustrate a flow chart of an exemplary computer-implemented process 500 for the redemption of points/miles in exchange for goods or services from online merchants unaffiliated with a loyalty program associated with the redeemed points/miles.

Process 500 may include a consumer joining 502 one or more loyalty programs associated with one or more business entities. A consumer may join any number of loyalty programs across different categorizations. For example, a consumer may be a loyalty member of multiple hotel chains, airlines, or even gas rewards programs. The disclosed is not meant to limit the number of loyalty programs a consumer may join. As a member of a loyalty program, a consumer may earn and accumulate rewards points that may be stored for later redemption, typically with the same business entity the rewards program is associated with. Points are typically earned based on interaction with the same business entity, such as purchases or bonus points awarded to the consumer, for example. After a consumer has joined at least one loyalty program, the consumer may then join an intermediary program, or a goods or services redemption server, in step 504. At this point, a consumer may link their loyalty program account(s) with the intermediary program. In one embodiment, an API may be used to provide an interface between the intermediary, or redemption, program and the one or more loyalty program accounts. An API may enable the transmission of data from the one or more loyalty programs to the intermediary program server, such as user account information (e.g., rewards points available, transaction history) or the like. Once a user's accounts are linked, the user may be prompted during a browsing session 506. In one embodiment, a user may be prompted, via a popup or via a browser extension, the availability of goods or services available for purchase using loyalty points. In another embodiment, a user may be presented with items for sale via a mobile application associated with the intermediary program server. A portal may be provided to an online merchant, for example, to enable a user to browse and purchase goods or services using loyalty points.

The process may include the selecting 508 of one or more goods and/or services for purchase. While browsing, the application or browsing extension described above may display to the user, via an overlay, points available, points needed to purchase a particular good or service, and points available after a purchase. Once one or more items have been selected, the process may include confirming 510 by the user the purchase of the one or more items. The process would then continue as described in conjunction with FIG. 5B.

In FIG. 5B, the process 500 may include receiving a virtual payment instrument 512 by the intermediary program server. The virtual payment instrument may be in the form of a credit card or similar type of payment (e.g., gift card, debit card, etc.). The virtual payment may include an account number, such as a 16-digit credit card number, and other identifying information necessary to make a credit card payment. The virtual payment may have an amount loaded in the amount equal to the cost of the selected one or more items by the user. In a request to the payment processor, the intermediary may request a virtual payment, including the cost of the item. The process may then include fulfilling 514 of the purchase with the online merchant utilizing the virtual payment instrument. The online merchant may then handle the shipping of the item as well as returns and other customer service.

The process 500 may include notifying 516 of the loyalty program of the purchase that was made via loyalty points. The notifying may be done by the intermediary program, for example. The notification may include details of the transaction conducted, including the amount of points used to complete the purchase. In at least one embodiment, the user's loyalty program account may be deducted in the amount of points used to complete the purchase. In another embodiment, the point deduction may include a commission charge for later reimbursement to the intermediary program. In some embodiments, the conversion rate of dollars to loyalty points may be predetermined. For example, the conversion rate may be contracted between the loyalty program and the redemption intermediary. The process 500 may include billing 518 of the intermediary server program an amount equal to the amount of the virtual credit cards. This billing may be done periodically, such as monthly, so as to not have to bill for each and every transaction individually. In one or more embodiments, billing may include an aggregate of all transactions conducted over a period of time, such as once a month or weekly. The process may then include billing of the one or more loyalty programs by the intermediary server to cover the cost of the billing made by payment processor. This billing may also be done periodically or on a per transaction basis. Additional data may also be provided once a purchase is completed via step 516. For example, SKU-level data collected during a user session may be transmitted to the loyalty program in addition to the purchase details. For example, the loyalty program may receive information regarding the user that made the purchase (e.g., shopper demographics), all products viewed during a session leading up to the final purchase including brands viewed and price points, time spent viewing items, or the like. In some embodiments, loyalty programs may leverage this collected data to further enhance a customer's experience on a more personal level.

Exemplary Computer-Implemented Method for a Virtual Payment

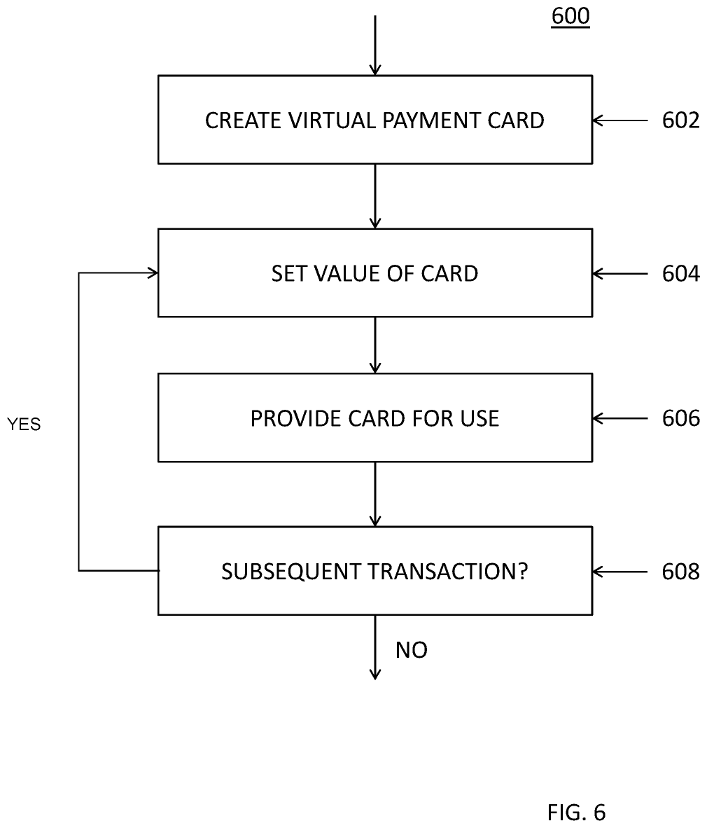

FIG. 6 illustrates a flow chart of an exemplary computer-implemented process 600 for the creation and usage of a virtual payment method. The process 600 may include creating 602 of a virtual payment card, such as by one or more payment processors described herein. In one or more embodiments, a one-time or a multi-use card may be created. The card may, for example, include data necessary to make a payment to an online merchant, such as an appropriate credit card number, billing zip code, expiration date, and merchant category code. Other information may be provided as well, such as virtual card balance or credit line data. In one or more embodiments, this information may be stored on a database associated with the payment processor. A multi-use virtual payment method may be used in some embodiments. A multi-use card may be associated with a user's loyalty redemption account and tracked by both the payment processor and the intermediary server. Alternatively, the user payment account information may be securely stored at the payment processor, such as in a secure database or cloud solution.

At step 602, a value of the payment card may be set. In some embodiments, the value is set to an exact amount equal to the intended purchase to be made from an online merchant. Alternatively, the value may be set to a higher amount to cover unexpected fees or surcharges that may arise. In some embodiments, the value may include commission fees of either the payment processor or intermediary server. Once the value is set and the user is associated with the card with appropriate information, such as the information described above, the payment card may be provided for use with the online merchant. In one embodiment, payment fields at the online merchant may be automatically populated with the appropriate information. At step 608, if there are no further transactions, the process ends. Alternatively, in the case of a multi-use card, the card may be re-used again with either the same online merchant or a different online merchant. In some embodiments, the virtual payment information may be stored by the online merchant for subsequent use.

### Exemplary Embodiments

In one aspect, a computing device including at least one processor in communication with a memory device is provided. The at least one processor may be configured to: (i) receive, from a loyalty program server, user data pertaining to at least one user; (ii) receive, from at least one merchant, data identifying one or more goods or services; (iii) deploy, to a device of the at least one user, loyalty program data and display the loyalty program data corresponding to the one or more goods or services via a pre-existing application, wherein the pre-existing application is a mobile application or a web browser extension (iv) receive, from at least one user device associated with the at least one user, a request to purchase at least one of the one or more goods or services; and (v) receive, from at least one payment server, payment information to complete the at least one requested purchase. The computing device may include additional, less, or alternate functionality, including that discussed elsewhere herein.

A further enhancement of the computing device may include wherein at least one processor is further configured to: (i) assign a point value to the identified one or more goods or services; and (ii) display an exchange ratio of the assigned point value to a currency of the user.

A further enhancement of the computing device may include wherein at least one processor is further configured to: notify the loyalty program server of the completed purchase, wherein the notification includes a point value of the purchased good or service.

A further enhancement of the computing device may include wherein at least one processor is further configured to: receive a bill in an amount equal the cost of the purchased good or service.

A further enhancement of the intermediary computing device may include wherein at least one processor is further configured to: send a bill for the amount to the loyalty program server.

A further enhancement of the intermediary computing device may include wherein a user makes a request to purchase during a browsing session via a desktop computer, a tablet PC or a mobile computing device.

A further enhancement of the intermediary computing device may include wherein at least one processor is further configured to: link an account of the user with the intermediary computing device with an account of the user with the loyalty program server.

In another aspect, a computer-implemented method for creating a virtual payment is provided. The computer-implemented method may be implemented by an intermediary computing device including at least one processor in communication with a memory device. The computer-implemented method may include (i) receiving a request, from a computing device, for a virtual payment instrument; (ii) creating the virtual payment instrument; (iii) setting a value of the virtual payment instrument; and (iv) providing the virtual payment instrument. The computer-implemented method may include additional, less, or alternate actions, including those discussed elsewhere herein.

A further enhancement of the computer-implemented method may include wherein the request includes a name of a user, a merchant code, and an amount;

A further enhancement of the computer-implemented method may include wherein the set value is based on the amount.

A further enhancement of the computer-implemented method may include wherein a credit limit of the virtual payment instrument is equal to the amount.

A further enhancement of the computer-implemented method may include wherein the virtual payment instrument is a credit card, a debit card, a cash card, or a gift card.

A further enhancement of the computer-implemented method may further include: (i) associating the virtual payment card with the user; and (ii) reusing the virtual payment card for the user in a subsequent transaction.

A further enhancement of the computer-implemented method may further include: canceling the virtual payment card after a single use.

In yet another aspect, a non-transitory computer-readable storage media having computer-executable instructions embodied thereon may be provided. The computer-executable instructions may cause the processor to: (i) create, for a consumer, a loyalty rewards account with at least one of a plurality of loyalty rewards programs; (ii) create, for the consumer, a loyalty redemption account with at least one loyalty redemption server; (iii) provide an interface between the loyalty rewards account and the loyalty redemption account; (iv) display, to the consumer, one or more of a plurality of goods or services provided by one or more of a plurality of online merchants; (v) receive, from the consumer, a selection of at least one of the one or more of the plurality of goods or services; and (vi) provide, to the consumer, a secure method of payment to purchase the selected good or service. The computer-readable storage may include additional, less, or alternate actions, including those discussed elsewhere herein.

A further enhancement of the computer-readable storage may further include instructions to: provide an overlay graphic indicating an exchange rate of the one or more of goods and services between loyalty points and a currency native to the consumer.

A further enhancement of the computer-readable storage may further include wherein the exchange rate is contracted between the at least one of the plurality of loyalty rewards programs and the loyalty redemption server.

A further enhancement of the computer-readable storage may further include wherein the at least one of the plurality of loyalty rewards programs and the loyalty redemption server interface via an application programming interface.

A further enhancement of the computer-readable storage may further include wherein the overlay graphic is provided via a browser extension for display to the consumer.

A further enhancement of the computer-readable storage may further include wherein the one or more of the plurality of goods or services of the plurality of online merchants is displayed on a screen of a mobile application associated with the loyalty redemption server.

The described Intermediary Server may provide more than one company, such as travel, gas, credit card, or the like, the ability for their loyalty members to redeem accumulated membership points/miles/cashback with another merchant, such as an online merchant, that is unaffiliated with the consumer's loyalty program. In some embodiments, a consumer may be a member of more than one loyalty program. A consumer, while browsing a merchant's website (e.g., Amazon®), may be shown a popup window, or the like, via a web browser extension, such as a Google Chrome® extension. The browser extension popup may indicate the ability for the consumer to redeem points with the merchant. Other information may be provided as well, such as available point balance, which loyalty program balances may be available for redemption, exchange rates, and special deals, for example. While browsing and selecting certain products sold online by the merchant, the browser extension may indicate total point cost of the product, based on a previously-agreed upon exchange rate. In some embodiments, the agreed upon exchange rate may be established between the loyalty program and the merchant. In another embodiment, the agreed upon exchange rate may be established between the loyalty program and the intermediary server.

The disclosed embodiments are not limited by any particular customer loyalty program. The loyalty programs disclosed herein are merely described to assist in providing a complete understanding of the claimed invention.

One exemplary customer loyalty program is the LifeMiles Loyalty Program, which has approximately 8.6 million members as of July 2019. LifeMiles Loyalty Program members live in many different countries, such as Guatemala, El Salvador, Honduras, Nicaragua, Costa Rica, Panama, Ecuador, Peru and the United States. LifeMiles has Co-branded credit cards with: BBVA, Scotiabank, BAC Credomatic, Bancolombia (Centro America), Fichosa, Banco Promerica, Mercantil Santa Cruz.

Another exemplary customer loyalty program is the LatamPass Loyalty Program, which has 30 million members as of July 2019. LatamPass recently acquired TAM Airlines Loyalty Program in Brazil) and has members in many countries including Argentina, Peru, Chile, Uruguay, Ecuador and Colombia. LatamPass has co-branded credit cards with: BCP, Banco Santander, Banco Hail, Banco de Bogota, Banco Pichincha, BBVA Frances.

Sanctions Screening

The intermediary server may perform sanctions screening on the members that use its services. A screening may include the utilization of software to meet legal requirements and prevent or report money laundering activities. Different processes may be performed, such as Anti-Money Laundering (AML) and Know Your Customer (KYC) processes, for example. Members may be screened prior to their first transaction as well on a frequent basis, such as on an annual basis. Software-based tools such as SwiftDil may be used to perform the screening.

Exception Handling

The intermediary server may provide loyalty members with support through the complete process of the transaction. At any stage of the transaction, customers may submit tickets that one or more entities, such as a customer service team, may handle according to an existing service level agreement (SLA) with each loyalty program. If the program member is unable to complete their transaction (Full or Partial) or if a transaction is reversed, funds may be returned by the merchant to the intermediary. Once returned, the intermediary server may notify the loyalty program to return the unused points to the member's loyalty account. Any funds collected from the loyalty program may be returned by the intermediary server via a credit on the next bill sent by the intermediary server to the loyalty program.

As will be appreciated based on the foregoing specification, the above-described embodiments of the disclosure may be implemented using computer programming or engineering techniques including computer software, firmware, hardware or any combination or subset thereof. Any such resulting program, having computer-readable code means, may be embodied or provided within one or more computer-readable media, thereby making a computer program product, i.e., an article of manufacture, according to the discussed embodiments of the disclosure. The computer-readable media may be, for example, but is not limited to, a fixed (hard) drive, diskette, optical disk, magnetic tape, semiconductor memory such as read-only memory (ROM), and/or any transmitting/receiving medium such as the Internet or other communication network or link. The article of manufacture containing the computer code may be made and/or used by executing the code directly from one medium, by copying the code from one medium to another medium, or by transmitting the code over a network.

These computer programs (also known as programs, software, software applications, “apps”, or code) include machine instructions for a programmable processor, and can be implemented in a high-level procedural and/or object-oriented programming language, and/or in assembly/machine language. As used herein, the terms “machine-readable medium” “computer-readable medium” refers to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The “machine-readable medium” and “computer-readable medium,” however, do not include transitory signals. The term “machine-readable signal” refers to any signal used to provide machine instructions and/or data to a programmable processor.

As used herein, a processor may include any programmable system including systems using micro-controllers, reduced instruction set circuits (RISC), application specific integrated circuits (ASICs), logic circuits, and any other circuit or processor capable of executing the functions described herein. The above examples are example only, and are thus not intended to limit in any way the definition and/or meaning of the term “processor.”

As used herein, the terms “software” and “firmware” are interchangeable, and include any computer program stored in memory for execution by a processor, including RAM memory, ROM memory, EPROM memory, EEPROM memory, and non-volatile RAM (NVRAM) memory. The above memory types are example only, and are thus not limiting as to the types of memory usable for storage of a computer program.

In one embodiment, a computer program is provided, and the program is embodied on a computer readable medium. In an example embodiment, the system is executed on a single computer system, without requiring a connection to a sever computer. In a further embodiment, the system is being run in a Windows® environment (Windows is a registered trademark of Microsoft Corporation, Redmond, Wash.). In yet another embodiment, the system is run on a mainframe environment and a UNIX® server environment (UNIX is a registered trademark of X/Open Company Limited located in Reading, Berkshire, United Kingdom). The application is flexible and designed to run in various different environments without compromising any major functionality. In some embodiments, the system includes multiple components distributed among a plurality of computing devices. One or more components may be in the form of computer-executable instructions embodied in a computer-readable medium. The systems and processes are not limited to the specific embodiments described herein. In addition, components of each system and each process can be practiced independent and separate from other components and processes described herein. Each component and process can also be used in combination with other assembly packages and processes.

As used herein, an element or step recited in the singular and preceded by the word “a” or “an” should be understood as not excluding plural elements or steps, unless such exclusion is explicitly recited. Furthermore, references to “example embodiment” or “one embodiment” of the present disclosure are not intended to be interpreted as excluding the existence of additional embodiments that also incorporate the recited features.

The patent claims at the end of this document are not intended to be construed under 35 U.S.C. § 112(f) unless traditional means-plus-function language is expressly recited, such as “means for” or “step for” language being expressly recited in the claim(s).

This written description uses examples to disclose the disclosure, including the best mode, and also to enable any person skilled in the art to practice the disclosure, including making and using any devices or systems and performing any incorporated methods. The patentable scope of the disclosure is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

I claim:

1. A loyalty program (LP) computing device comprising at least one processor in communication with a memory device, the at least one processor configured to:
receive, from a loyalty program server, user data pertaining to at least one user;
receive, from at least one merchant, data identifying one or more goods or services;
deploy, to a device of the at least one user, loyalty program data and display some of the loyalty program data corresponding to the one or more goods or services via a pre-existing application, wherein the pre-existing application is a mobile application or a web browser extension;
receive, from the device associated with the at least one user, a request to purchase at least one of the one or more goods or services; and
receive, from at least one payment server, payment information to complete the at least one requested purchase.

2. The computing device of claim 1, wherein the at least one processor is further configured to:
assign a point value to the identified one or more goods or services; and
display an exchange ratio of the assigned point value to a currency of the user.

3. The computing device of claim 1, wherein the at least one processor is further configured to:
notify the loyalty program server of the completed purchase, wherein the notification includes a point value of the purchased good or service.

4. The computing device of claim 1, wherein the at least one processor is further configured to:
receive a bill in an amount equal the cost of the purchased good or service.

5. The computing device of claim 4, wherein the at least one processor is further configured to:
send a bill for the amount to the loyalty program server.

6. The computing device of claim 1, wherein the user makes the request to purchase during a browsing session via a desktop computer, a tablet PC or a mobile computing device.

7. The computing device of claim 1, wherein the intermediary computing device is further configured to:
link an account of the user with the intermediary computing device with an account of the user with the loyalty program server.

8. A computer-based method for creating a virtual payment, said method comprising:
receiving a request, from a computing device, for a virtual payment instrument;
creating the virtual payment instrument;
setting a value of the virtual payment instrument;
providing the virtual payment instrument.

9. The method of claim 8 wherein the request includes a name of a user, a merchant code, and an amount;

10. The method of claim 9, wherein the set value is based on the amount.

11. The method of claim 9, wherein a credit limit of the virtual payment instrument is equal to the amount.

12. The method of claim 8, wherein the virtual payment instrument is a credit card, a debit card, a cash card, or a gift card.

13. The method of claim 8, further comprising:
associating the virtual payment card with the user; and
reusing the virtual payment card for the user in a subsequent transaction.

14. The method of claim 8, further comprising:
canceling the virtual payment card after a single use.

15. At least one non-transitory computer-readable storage media having computer-executable instructions embodied thereon, wherein when executed by at least one processor, the computer-executable instructions cause the processor to:
create, for a consumer, a loyalty rewards account with at least one of a plurality of loyalty rewards programs;
create, for the consumer, a loyalty redemption account with at least one loyalty redemption server;
provide an interface between the loyalty rewards account and the loyalty redemption account;
display, to the consumer, one or more of a plurality of goods or services provided by one or more of a plurality of online merchants;
receive, from the consumer, a selection of at least one of the one or more of the plurality of goods or services; and
provide, to the consumer, a secure method of payment to purchase the selected good or service.

16. The media of claim 15, wherein the processor is further programmed to:
provide an overlay graphic indicating an exchange rate of the one or more of goods and services between loyalty points and a currency native to the consumer.

17. The media of claim 16, wherein the exchange rate is contracted between the at least one of the plurality of loyalty rewards programs and the loyalty redemption server.

18. The media of claim 16, wherein the at least one of the plurality of loyalty rewards programs and the loyalty redemption server interface via an application programming interface.

19. The media of claim 16, wherein the overlay graphic is provided via a browser extension for display to the consumer.

20. The media of claim 15, wherein the one or more of the plurality of goods or services of the plurality of online merchants is displayed on a screen of a mobile application associated with the loyalty redemption server.
